(19) United States
(12) Patent Application Publication
(10) Pub. No.: US 2010/0170374 A1
(43) Pub. Date: Jul. 8, 2010

(54) WINDOW COVERING MODIFICATION APPARATUS

(76) Inventor: ROMAN JOSEPH GALAS, MT. PLEASANT, SC (US)

Correspondence Address: KO patents, LLC, 4800 Baseline Road, Suite 104, #266, Boulder, CO, 80303, US

(21) Appl. No.: 12/646,086

(22) Filed: Dec. 23, 2009

Related U.S. Application Data
(60) Provisional application No. 61/204,188, filed on Jan. 2, 2009.

(51) Int. Cl. B26D 7/02; B26D 7/27; B26D 1/10

(52) U.S. Cl. 83/13; 83/454; 83/522.11; 83/468.2; 83/464

(57) ABSTRACT

An apparatus for modifying window blind assemblies. The apparatus may have a base plate and a wall, the base plate and wall supporting the blind assembly. The apparatus may have a horizontal clamp assembly attached to the base plate that may secure a side of the blind assembly. The wall may support a slide clamp assembly. The slide clamp assembly may be slidably connected along the wall and pivotally adjusted to secure an adjacent side of the blind assembly. A cutting assembly may be attached to the base plate. The cutting assembly may have a saw guide for securing a saw that may be positioned to modify the blind assembly along a plane. The apparatus provides measuring and cutting the adjacently bundled blinds together along a plane, until the bundled blind assembly is again secured within the apparatus for modifying another end of the bundled blinds, for symmetry purposes.

### CROSS REFERENCE TO RELATED APPLICATIONS

This patent application claims priority to and benefit of U.S. Provisional Patent Application 61/204,188 filed 2 Jan. 2009 by Roman Joseph Galas, the entire contents of which are hereby expressly incorporated by reference.

### BACKGROUND

There is a large market for window coverings, in both the residential and commercial construction industries. Typical window coverings include horizontal slat and vertical slat types of blinds. Typical sizes produced in mass by factories or distributors are 1″ and 2″ vinyl and aluminum blind slats, with a window blind assembly including a headrail, a bottom rail on the horizontal blind assembly, the blind slats, and a wand for opening and closing the slats. The blinds are mounted within window frames and most often require modification to the width or length of the blind assembly to fit specific or custom window spaces.

Manufacturing of custom orders of blind sizes to fit specific window spaces is relatively expensive for the customer. Similarly, large expenses and time commitments are incurred by customers purchasing stocked sizes of blinds and concurrently needing to then customize the blinds in commercial stores that use large, costly machines and require extra labor to customize the blind sizes, often having to size each individual blind slat at a time, instead of cutting the entire blind assembly at once.

Blind assembly cutting machines and hand tools have been disclosed and have appeared in the market. When cutting a blind assembly, the components of the blind assembly, including the headrail, bottom rail, and blind slats must be bundled and held down in order to achieve an effective and proper modification cut of the width or length of the blind assembly. Simply holding down the end of the blind assembly will not provide for an even cut along the bundled blind slats and may create uneven cuts along the entire blind assembly.

Machines with complicated parts and components for cutting will jam and break after a few uses. Feeding the blind assembly into a feeder and cutter can also create issues with an uneven cut along the assembly and may become ineffective due to proper training on how to use the feeder and cutter and loss of control of the cutting once the blind assembly is placed into the feeder and cutter. Maintenance of the cutting machines and complicated machine assemblies create problems with effectively and easily cutting blind assemblies. Use of specific dies within blind cutting machines for accommodating headrails and bottom rails and bundled slats does not provide for multiple types of blinds being able to be modified with one machine, requiring multiple dies and machines to be created to accommodate multiple sizes of blind assemblies. Hand-held tools do not provide an effective and easy modification of an entire blind assembly, often creating an uneven modification or simply an incomplete cut due to the complexity and.

For the foregoing reasons, there is a need for a window blind modification unit that can inexpensively and effectively hold down and modify window blind assemblies, performing the modifications easily in both a mobile environment or within a retail store.

### SUMMARY

A portable apparatus for cutting and resizing the width or length of window blind assemblies, the blinds being of the horizontal or vertical type with a head rail and bottom rail encompassing a plurality of blind slats commonly aligned and adjacently bundled together while undergoing a modification process. The apparatus may also provide modification for other types of window coverings, including roller shades and other blind shade assemblies. The apparatus provides measuring and cutting the adjacently bundled blinds together along one plane ensuring an even cut with no need to move the blinds during the cutting process once properly held-down within the apparatus, until the bundled blind assembly is rotated and secured again into the apparatus for cutting the other end of the bundled blinds, for symmetry purposes.

The apparatus may have a base plate and a wall, the base plate and wall supporting the bundled blind assembly. The apparatus may have a horizontal clamp assembly attached to the base plate that is readily conformable to different sizes of blind assemblies and may secure a side of the blind assembly. The wall may support a slide clamp assembly. The slide clamp assembly may be slidably adjusted along the wall pivotally adjusted to secure an adjacent side of the blind assembly. A cutting assembly may be attached to the base plate. The cutting assembly may have a saw guide for securing a saw that may be positioned to cut the blind assembly along a common plane.

The apparatus may also provide a ruler along the wall that may guide the measuring and amount of material to be modified from the window blind assembly.

The apparatus may also provide a channel in the base plate and an opening in the wall, both along the common cutting plane of the cutting assembly. The channel in the base plate may accommodate a complete cut of the blind assembly, ensuring the cutting means, such as a saw blade, cuts below the surface of the base plate and beyond the blind assembly. The opening in the wall may also assist with a complete cut of the blind assembly, allowing the saw to move beyond the blind assembly.

The apparatus may also provide a cut length stop slidably attached to the base plate. The cut length stop may be positioned to secure an end of the blind assembly and may also be positioned to not interfere with the end of the blind assembly for longer modification cuts of the blind assembly.

These and other features, aspects, and advantages of one embodiment of the present invention will become understood with reference to the following description and appended claims. Before explaining at least one embodiment in detail, it is to be understood that the embodiments are not limited to the details of construction and to the arrangements of the components set forth in the following description and is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out several purposes recited. It is important, therefore, that the claims be regarded as including such equivalent constructions.

### BRIEF DESCRIPTION OF THE DRAWINGS

FIG. 1 is a top perspective view of one embodiment of a window blind modification apparatus;

FIG. 2 is a bottom perspective view of the apparatus in FIG. 1;

FIG. 3 is a top perspective view of certain components of the apparatus in FIG. 1, with other components removed;

FIG. 4 is a bottom perspective view of certain components of the apparatus in FIG. 1, with other components removed;

FIG. 5 is an exploded perspective view of a horizontal clamp assembly of the apparatus in FIG. 1;

FIG. 6 is a somewhat fragmentary perspective view of a horizontal clamp assembly attached to the apparatus in FIG. 1, with other components removed;

FIG. 7 is an exploded perspective view of a slide clamp assembly of the apparatus in FIG. 1;

FIG. 8 is a somewhat fragmentary front perspective view of a slide clamp assembly attached to the apparatus in FIG. 1, with other components removed;

FIG. 9 is a somewhat fragmentary rear perspective view of a slide clamp assembly attached to the apparatus in FIG. 1, with other components removed;

FIG. 10 is a top perspective view of certain components of the apparatus in FIG. 1, with other components removed;

FIG. 11 is a top perspective view of a cut length stop attached to the apparatus in FIG. 1, with other components removed;

FIG. 12 is a top perspective view of a window blind assembly secured to the apparatus in FIG. 1;

FIG. 13 is a side view of a bundled blind assembly secured to the apparatus in FIG. 1;

FIG. 14 is a top perspective view of the apparatus in FIG. 1, in another position; and

FIG. 15 is a further embodiment of the apparatus.

### DETAILED DESCRIPTION

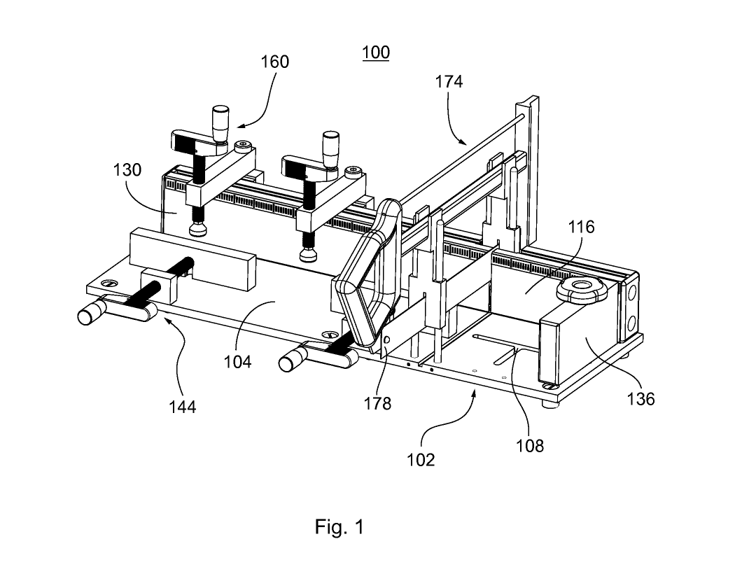

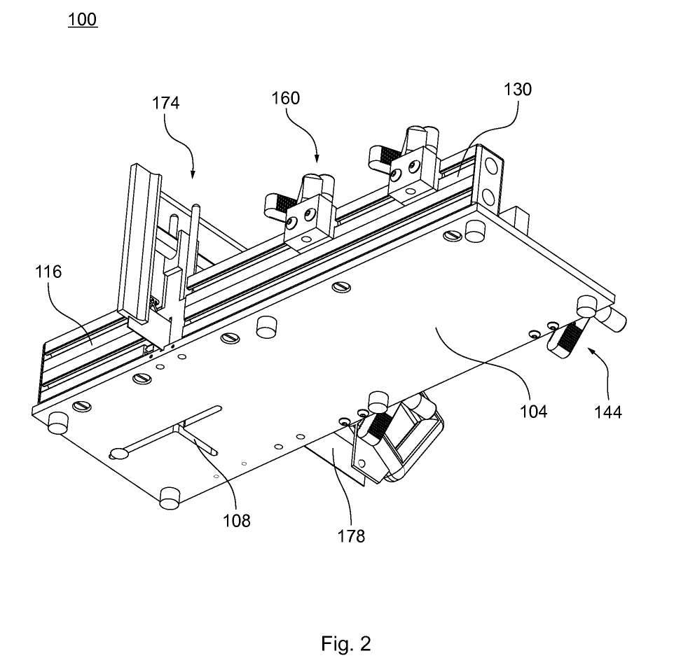

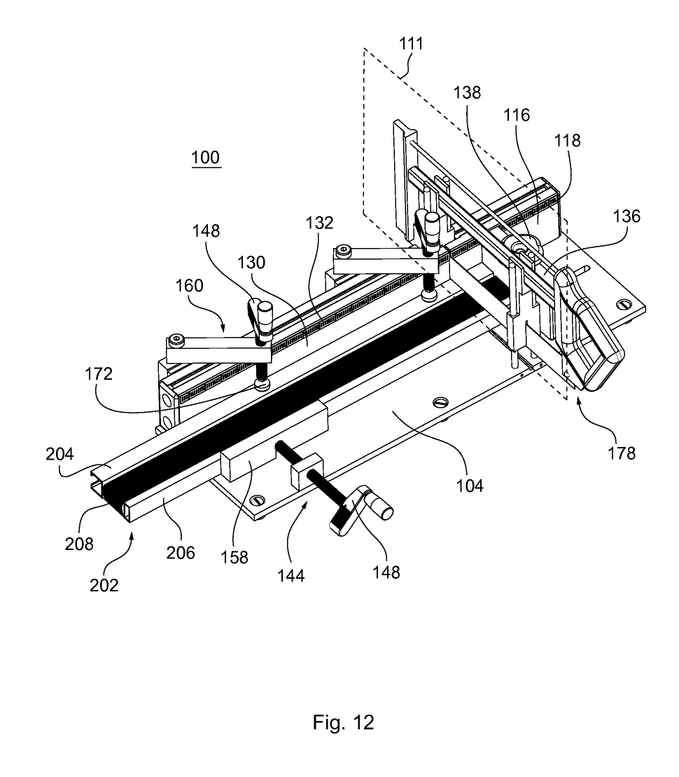

Referring in detail to the drawings, there is shown in FIGS. 1 to 14 one embodiment of a window blind modification apparatus 100 for trimming bundled blind assemblies, the blind assemblies of the general type having a headrail, horizontal blind slats with a bottom rail, and vertical blind slats. A bundled window blind assembly is shown in FIG. 12. Typically, the apparatus may be portable and rest on any suitable form of work table or bench (not shown) which functions to support the apparatus 100 at a suitable working height for modifying window blind assemblies.

It is desirable to provide for modifying the entire window blind assembly simultaneously, including the headrail, the bottom rail, and the bundled blind slats, the window blind assembly being modified while it is secured and without movement within the apparatus until the window blind assembly is released from the apparatus, moved or rotated and secured again to the apparatus for further modification to the other side of the blind assembly for symmetry.

The window blind modification apparatus 100 in this embodiment may comprise a jig assembly 102, a horizontal clamp assembly 144 attached to a base plate 104 of the jig assembly, a slide clamp assembly 160 attached to a left wall 130 of the jig assembly, and a cutting assembly 174 attached to the base plate 104 of the jig assembly, all described further. A window blind assembly (as shown in FIG. 12) may be secured on the base plate 104 and against the left wall 130 and a right wall 116 using the horizontal clamp assembly 144 and the slide clamp assembly 160 and may be positioned within the cutting assembly 174 which may have a saw 178 to modify the desired amount from an end of the window blind assembly.

The window blind assembly may then be rotated and secured again to the jig assembly 102 using the horizontal clamp assembly 144 and slide clamp assembly 160 and may be positioned within the cutting assembly 174 to be modified with the saw 178 for a simultaneous modification of the window blind assembly, for a symmetrical modification of a window blind assembly. A cut length stop 136 may be slidably attached and secured to the jig assembly 102 along a guide slot 108 on the base plate. The window blind assembly may be supported by the base plate 104 and the right wall 116 and the cut length stop 136 may be used to secure a position on the jig assembly that will ensure the same amount of material cut by repeatedly using the apparatus for multiple window blind assemblies.

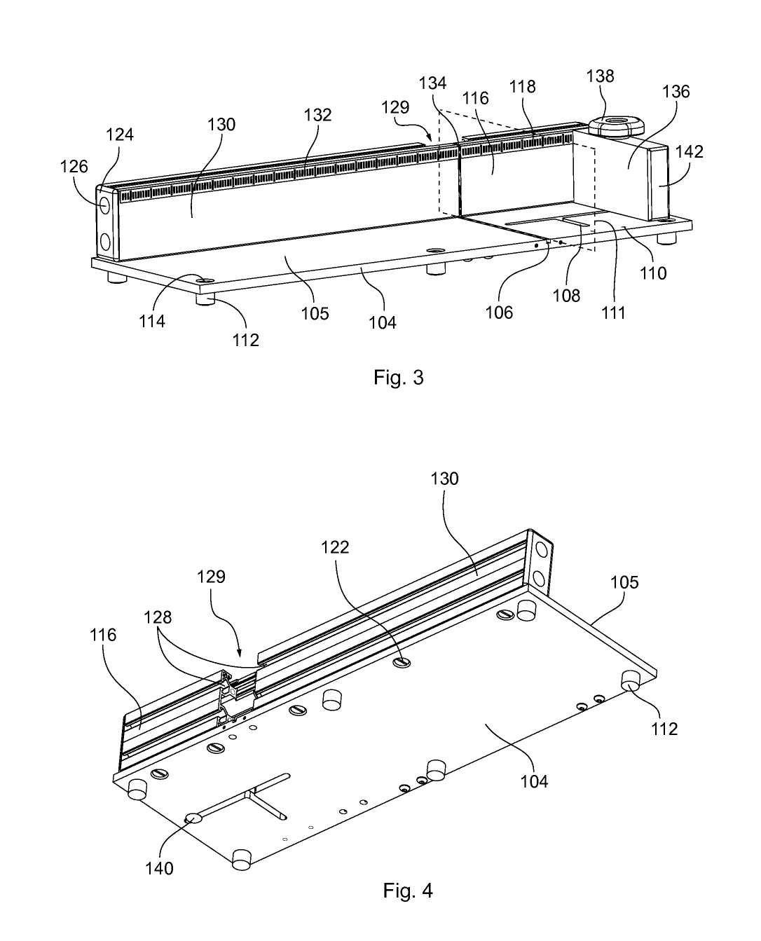

The jig assembly 102 may comprise the base plate 104 and the left wall 130 and the right wall 116, more specifically shown in FIG. 3 and FIG. 4. The base plate 104 may be of rectangular shape and may be made of a rigid material, such as aluminum. A top surface 105 of the base plate 104 may be flat, as to accommodate an even working space to support the window blind assembly and to ensure an even cut and no damage along the window blind assembly. The base plate 104 may be of sufficient size for supporting a majority of the bundled window blind assembly, on the order of 24″ long by 8″ wide.

The base plate 104 may have a cutting groove 106 along the width of the base plate to accommodate a cutting mechanism, such as a saw 178, to travel beyond the top surface 105 of the base plate 104 and achieve a complete cut of the bundled window blind assembly. The cutting groove 106 may form a cutting plane 111 from which the cutting mechanism may align with in order for a consistent cut along the window blind assembly. The base plate 104 may have a shaped guide slot 108 in which a cut length stop 136 secured to the base plate 104 with a bolt 140 may travel along, the cut length stop being secured to the base plate with a knob 138 connected to the bolt 140, described further, and assist with the securing and measuring of the window blind assembly to be modified.

The base plate 104 may also have tether attachment holes 110, in which to connect miscellaneous components to assist with the modifying of the bundled window blind assembly and to assist with post-cutting operations. These components are not shown but may include a block attached to a tether that may be secured to the base plate 104 through the tether attachment hole 110 to insert into the headrail of the window blind assembly to support the headrail as the window blind assembly is modified to support the head rail. The tether attachment holes 110 may include a file attached to a tether that is attached to the base plate 104 through the tether attachment 110 hole, the file used to remove unwanted fragments or burrs on the ends of the window blind slats and rails after the cutting has been performed.

The base plate 104 may have a plurality of base plate feet 112 attached and fastened on an underside of the base plate. Six feet 112 are shown in the present embodiment. The base plate feet 112 may be made of a rubber-type material, co-molded around a metal insert with threads to receive a base plate foot screw 114, or other securing means, for attaching the base plate feet 112 to the base plate 104. The base plate feet may be attached by other means, such as glue, a rivet mechanism, or weldment. The base plate feet 112 may be ½″ in height as to assist with stability of the apparatus and vibration absorption while the apparatus is in use. The base plate foot screws 114 may be countersunk beneath the top surface 105 of the base plate 104, for maintaining a flat working surface on the apparatus for modifying the window blind assemblies.

A left wall 130 and a right wall 116 may be mounted to the base plate 104, the right and left walls mounted in the same plane to each other and attached parallel near an edge along the length of the base plate 104 to allow for a working area on the top surface 105 of the base plate 104. The left and right walls, 130 and 116, may be made of extruded aluminum, or other rigid material, and mounted to the base plate 104 using rear wall screws 122 or other securing means. The walls may be attached to the base plate providing a wall opening 134 between the walls. The wall opening 134 may accommodate the cutting assembly, and a cutting mechanism such as a saw, to glide between the walls and form a cutting plane 111 in which to cut the bundled window blind assembly that may be secured against the left and right walls. The wall opening 134 may be in the same plane as the cutting groove 106, again accommodating a continuous cutting plane 111 on which to cut.

The left wall 130 and the right wall 116 may also provide a wall space 129 on the rear face of the walls to accommodate attachment of the cutting assembly to the base plate. The center plane of the wall space may be in the same plane as the wall opening and cutting plane 111, providing for the continuous plane on which to cut using the cutting assembly.

The left wall 130 and the right wall 116 may have an extruded profile that accommodates channels 128 within the walls for attaching the slide clamp assembly 160, described further. The walls may also have end caps 124, which may be secured with end cap fasteners 126, both for aesthetic look of the ends of the walls and to contain the slide clamp assembly 160 along the length of the left wall 130 and the right wall 116 if a slide clamp assembly 160 is also attached to the right wall 116. The end caps 124, along with the end cap fasteners 126, may be made of plastic and may fully cover the raw edge of the walls, preventing possible damage or injury to the window blind assembly or the user. The end caps 124 may plug onto the walls while the end cap fasteners 126 engage with the channels 128 in the walls. End caps may also be secured to the ends of the rear walls in other ways, such as glue, weld, or snap-fit.

A left ruler 132 and a right ruler 118 may be attached to the left wall 130 and right wall 116, to assist with measuring the window blind assemblies and assist the user in knowing the amount being cut from the end of the window blind assembly. The rulers, 132 and 118, may be adhesively attached to the walls 130 and 116, or may be machined or etched onto the walls. The rulers may be attached or conveyed the the section of the walls that would extend above the window blind assembly secured along the rear walls in order for accessibility to the value of the measurement taken from the rulers while the window blind assembly is in place and secured to the jig assembly. The ruler may also be attached or conveyed along the top surface of the walls, to accomplish the same accessibility of the values.

The rulers, 118 and 132, may measure in increments of ⅛″, as this is usually the industry standard increment for modifying window blinds. The origin of the left ruler 132 and the right ruler 118 may be at the center of the cutting plane 111, centered along the center of the cutting groove 106 and wall opening 134. The left and right rulers, 132 and 118, may then measure in positive directions from their origins along their respective directions along the left and right walls, 130 and 116. When the window blind assembly in secured within the jig assembly 102, the right ruler 118 may indicate how much will be modified from the window blind assembly.

The cut length stop 136 may be secured to the base plate 104, using the knob 138 attached to the cut length stop 136 with the bolt 140. The right ruler 118 may assist with placing the cut length stop 136 in the proper location as to remove a pre-determined amount from the window blind assembly before securing the window blind assembly to the jig assembly. The cut length stop 136 may also be moved out of the way of the window blind assembly in order to cut more of the window blind assembly, described further.

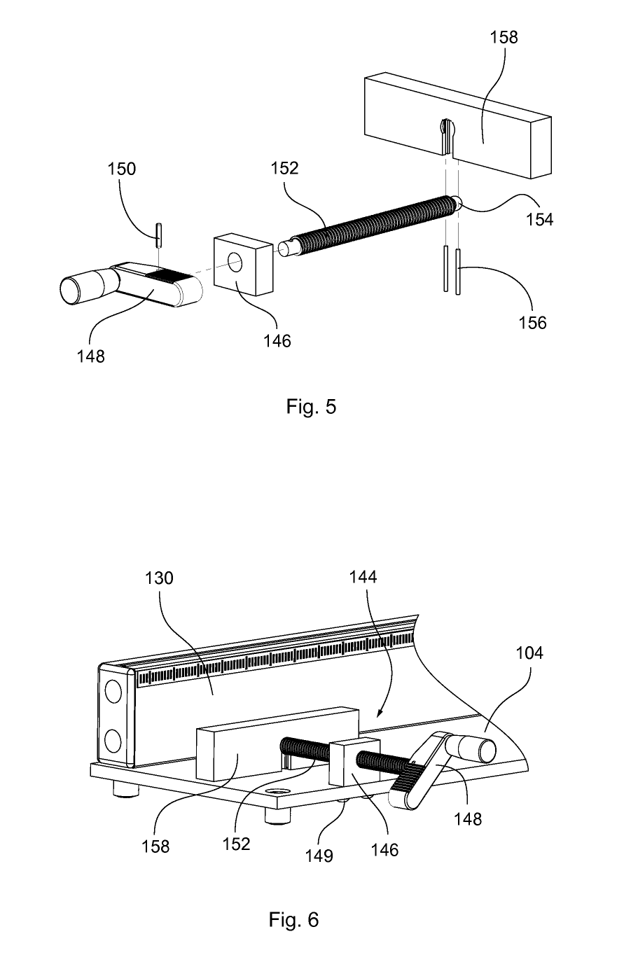

The horizontal clamp assembly 144 may be attached to the base plate 104 and may be positioned, may be manually extended or retracted, to accommodate different sizes of window blind assemblies, as shown in FIG. 5 and FIG. 6. The horizontal clamp assembly 144 comprises a horizontal clamp base block 146, a horizontal clamp bar 158, a horizontal threaded clamp shaft 152, and a clamp handle 148. The horizontal clamp base block 146 may be secured to the base plate 104, using screws 149 or other securing means. The threaded clamp shaft 152 may connect the clamp bar 158 and the clamp handle 148 and move through the base block 146, the base block having a threaded hole for receiving the threaded clamp shaft 152 and allowing the threaded clamp shaft 152 and the clamp bar 158 to advance or retract along the base plate 104. The clamp handle 148 may be attached to the clamp shaft 152 using a pin 150.

The clamp shaft 152 may have a ball bearing 154 attached to the opposite end of the threaded clamp shaft 152 from connection to the clamp handle 148 for connection to the clamp bar 158. The ball bearing 154 may connect into the clamp bar 158 and may be secured with attachment pins 156, as to allow rotation and tightening of the clamp assembly, using the clamp bar 158 resting against the base plate 104 as a force against the rotation of the clamp assembly 144, allowing for movement and tightening of the clamp assembly along the base plate 104, towards the left wall 130 and right wall 116 and against the window blind assembly placed in between the walls and the horizontal clamp assembly 144. A plurality of horizontal clamp assemblies 144 may be attached to the base plate 104, for multiple points of contact along the window blind assembly, the present apparatus having two horizontal clamp assemblies. The horizontal clamp assembly 144, and the slide clamp assembly 160, may also comprise clamping mechanisms such as telescoping rods or toggle clamps.

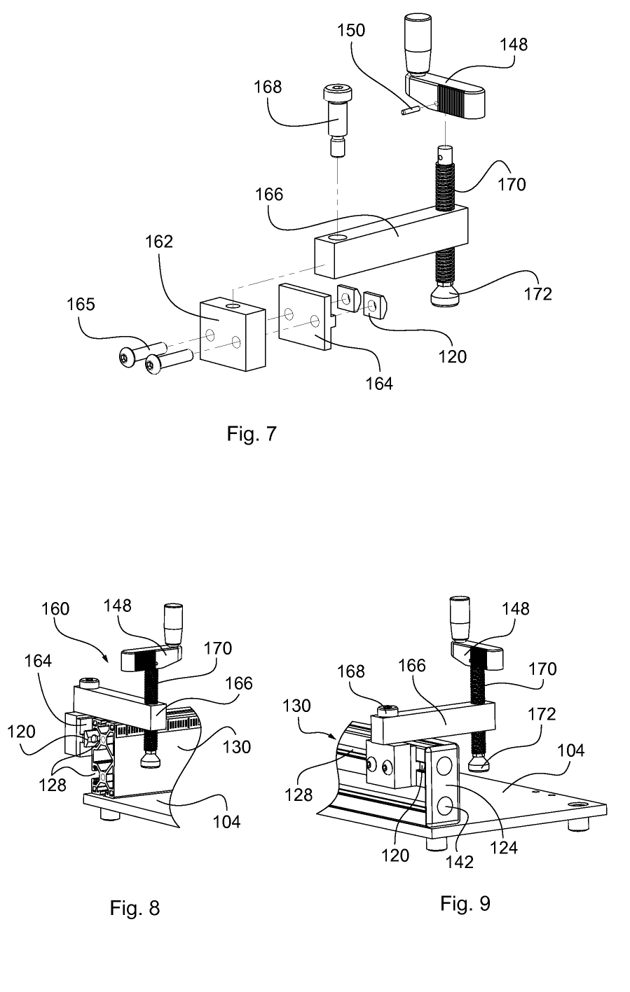

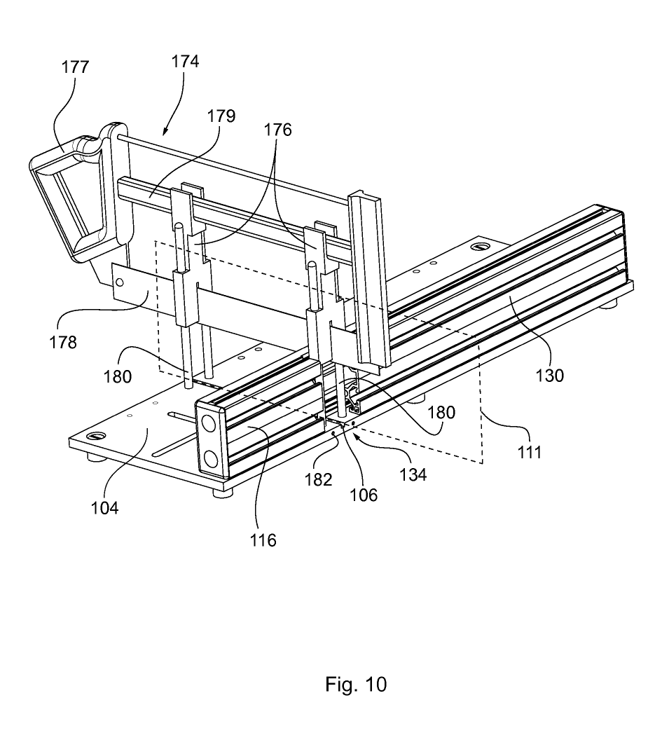

The slide clamp assembly 160 may be attached to the left wall 130 of the jig assembly. The slide clamp assembly 160 may also be attached to the right wall 116 of the jig assembly, but this configuration is not shown in this embodiment. As shown in FIG. 7, FIG. 8 and FIG. 9, the slide clamp assembly comprises a slide clamp base block 162, a slide clamp arm 166, a slide threaded clamp shaft 170, and a pivot foot 172.

The slide clamp base block 162 may attach to a bearing pad 164 that may secure to the left wall 130 using a combination of slide clamp screws 165 and t-nuts 120. The slide clamp screws 165 may connect through the slide clamp base block 162 and the bearing pad 164, through the left wall 130 and connect with the t-nuts 120, connecting the slide clamp assembly 160 to the left wall 130.

The bearing pad 164 may be made of plastic or a nylon type of material and may make contact with the left wall 130. The t-nuts 120 slide within the wall channel 128 of the left wall 130, connecting with the bearing pad 164 and allowing the slide clamp assembly 160 to move along the left wall 130 for optimal placement of the clamp assembly against the window blind assembly for securing the window blind assembly against the base plate 104. After the slide clamp assembly 160 is placed on the left wall 130, the wall end cap 124 may be placed on the end of the left wall 130, preventing the slide clamp assembly from being removed from the apparatus unintentionally.

The slide clamp arm 166 of the slide clamp assembly 160 may be attached to the slide clamp base block 162 using a shoulder screw 168. The slide clamp arm 166 may extend over the left wall 130, and may hover over the window blind assembly. The shoulder screw 168 connecting the slide clamp arm 166 to the slide clamp base block 162 may allow for pivotal rotation of the slide clamp arm 166, for adjustable placement over and along the window blind assembly. The slide threaded clamp shaft 170 may be connected to the opposite end of the slide clamp arm 166 from the shoulder screw 168.

The clamp handle 148 may be attached to the slide threaded clamp shaft 170 with a pin 150 and the threaded clamp shaft may accommodate a pivot foot 172 at the opposite end of the slide clamp shaft from the clamp handle for contact with the window blind assembly. Once the slide clamp assembly 160 is positioned along the left wall 130 and the slide clamp arm 166 and pivot foot 172 are hovering over the window blind assembly, the clamp handle 148 may be turned, lowering the pivot foot 172 into contact with the window blind assembly, and securing the window blind assembly against the base plate 104.

A plurality of slide clamp assemblies 160 may be attached to the left wall 130 and the right wall 116, for multiple points of contact along the window blind assembly, the present apparatus having two slide clamp assemblies.

As shown in FIG. 10, the cutting assembly 174 may comprise saw guides 176, a saw 178, and guide rods 180. The guide rods 180 are attached to the base plate 104, as shown, with socket set screws 182, or other securing means. The guide rods 180 may extend upwardly from the base plate 104 and may symmetrically align the cutting assembly 174 with the wall channel 128 and the cutting plane 111. The wall opening 134 allows for the guide rods 180 to attach to the base plate 104 and provide a stable and secure cutting assembly 174 attached to the base plate 104.

The saw guides 176 may be slidably attached to the guide rods 180 and may support the saw support bar 179, that connects the saw 178 and saw handle 177, allowing for the cutting mechanism to be raised and lowered, using the saw handle 177, along the guide rods 180 for cutting the window blind assembly. The saw guides 176 also allow for the saw 178 and saw support bar 179 to move across the base plate by pulling and pushing on the saw handle 177 in a sawing motion for cutting the window blind assembly.

The guide rods 180 may be made of chrome steel or other rigid, slick material for ease of allowing the saw guides 176 to move up and down along the guide rod path. The saw guides 176 may be made of molded plastic and may be molded to accommodate and support different cutting means incorporated in the cutting assembly, such as different sized saws. Other cutting mechanisms may be placed on the apparatus as well for cutting the window blind assembly.

The saw 178 may be made of metal and may have a serrated edge (not shown) for effective cutting on the window blind assembly. The wall opening 134 between the left wall 130 and right wall 116 allow for the saw 178 to move between the walls, along the cutting plane 111. The cutting groove 106 in the base plate 104 allows for the saw 178 to extend beyond window blind assembly supported on the base plate 104, for a complete cut through the window blind assembly.

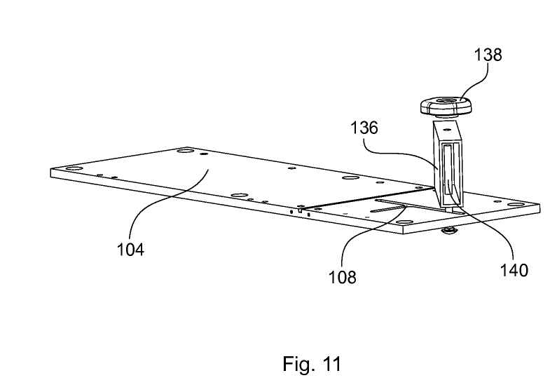

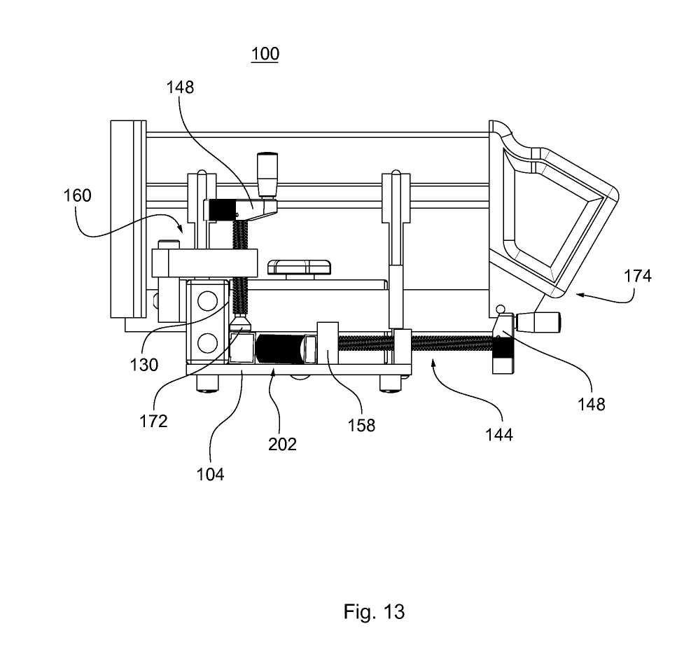

The cut length stop 136 is shown in more detail in FIG. 11. The cut length stop 136 may be made of an extruded hollow block of aluminum. A square neck bolt 140 may attach the cut length stop 136 to the base plate 104 and may connect with a knob 138 for tightening the cut length stop 136 into place along the guide slot 108 in the base plate 104. The knob 138 may be made of plastic. The square neck bolt 140 may restrict unwanted rotation of the cut length stop 136 along the guide slot 108, ensuring a generally perpendicular relation of the cut length stop 136 to the right wall 116. As shown in further detail in FIG. 13, the cut length stop 136 may also be positioned and secured within the guide slot 108 out of the way of the window blind assembly if desired for longer cuts of the window blind assembly that may extend past the base plate 104.

FIG. 12 shows the preferred embodiment 100 with the bundled window blind assembly secured to the apparatus and prepared for modification. A window blind assembly is shown as a typical horizontal blind assembly 202, comprising a headrail 204, a bottom rail 206, and a plurality of bundled window blind slats 208. The window blind assembly may be positioned on the base plate 104 and along the left wall 130 and right wall 116 and may be secured with the horizontal clamp assembly 144, tightening the horizontal clamp arm 158 with a handle 148 against the window blind assembly and also may be secured with the slide clamp assembly 160, tightening the pivot foot 172 with a handle 148 against the window blind assembly.

The cut length stop 136 may be positioned and secured with the knob 138 to achieve a desired cut amount from the end of the window blind assembly. The window blind assembly may be located within the cutting assembly 178 and may be secured through the cutting plane 111 to a desired measurement using the right ruler 118 as an indicator of the desired modification amount that may be cut from the window blind assembly.

FIG. 13 shows a side view of the preferred embodiment 100 with the bundled window blind assembly 202 secured to the apparatus and prepared for modification. The window blind assembly may be supported by the base plate 104 and the left wall 130 and the right wall (not shown). The slide clamp assembly 160 may secure the window blind assembly to the apparatus by turning the clamp handle 148 which may apply pressure to the window blind assembly from the pivot foot 172 contacting the window blind assembly and securing it along the base plate. The horizontal clamp assembly 144 may secure the window blind assembly to the apparatus by turning the clamp handle 148 which may apply pressure to the window blind assembly from the horizontal clamp bar 158 contacting the window blind assembly and securing is against the walls. The cutting assembly 174 may be raised up during the positioning of the window blind assembly on the base plate and the walls.

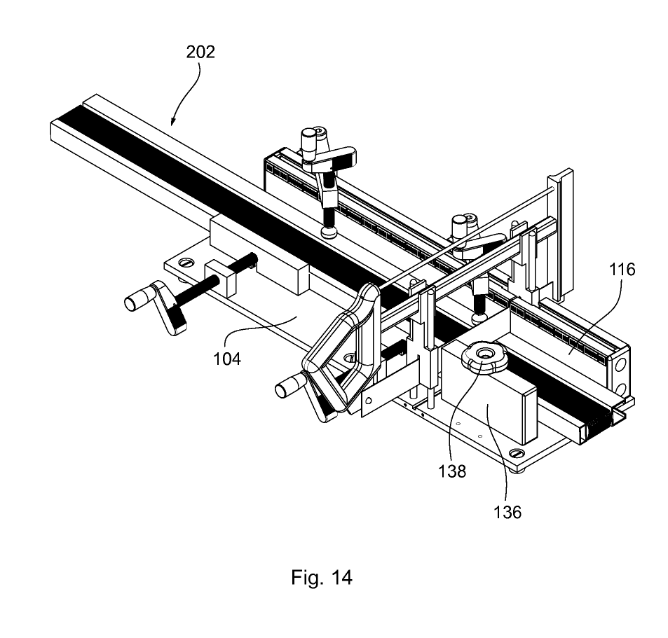

FIG. 14 shows the embodiment of the apparatus in a different position. As previously discussed, the cut length stop 136 may be moved to a location on the base plate 104 and secured within the guide slot (not shown) with the knob 138, so that the cut length stop 136 does not interfere with the window blind assembly 202 resting along the right wall 116 and extending beyond the right wall 116 and base plate 104 for a larger modification cut of the window blind assembly.

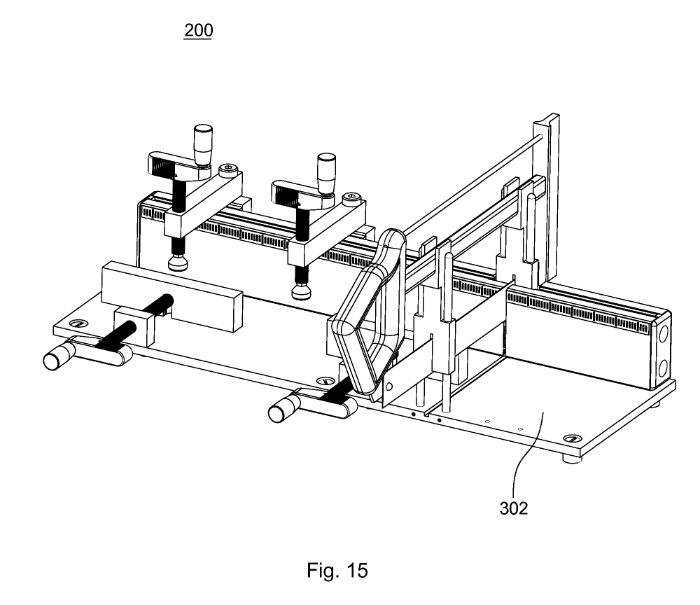

FIG. 15 shows another embodiment of the window covering modification apparatus. The apparatus 200 may comprise a base plate 302 that does not provide a guide slot for attaching a cut length stop to the apparatus.

What is claimed is:

1. An apparatus for modifying a window blind assembly, the apparatus comprising:
a base plate;
a wall extending upwardly from said base plate;
a first clamp assembly connected to said base plate, said first clamp assembly being manually extendable to secure said window blind assembly on said base plate and against said wall;
a second clamp assembly connected to said wall, said second clamp being manually extendable to secure said window blind assembly against said base plate; and
cutting means supported above said base plate for modifying said window blind assembly.

2. The apparatus of claim 1, said second clamp assembly being slidably connected to wall.

3. The apparatus of claim 1, further comprising a ruler attached along said wall, said ruler aligning with said window blind assembly.

4. The apparatus of claim 1, further comprising a cut length stop, said cut length stop slidably attached to said base plate.

5. The apparatus of claim 4, wherein cut length stop abuts an end of said window blind assembly.

6. The apparatus of claim 1, said cutting means comprising a saw.

7. The apparatus of claim 1, further comprising a plurality of feet, said feet attached to underside of said base plate.

8. An apparatus for modifying a window blind assembly, the apparatus comprising:
a base plate;
a wall extending upwardly from said base plate, said wall having an opening extending from said base plate upwardly along said wall;
a first clamp assembly connected to said base plate, said first clamp assembly being manually extendable to secure said window blind assembly on said base plate and against said wall and across said opening;
a second clamp assembly slidably connected to said wall, said second clamp being manually extendable to secure said window blind assembly against said base plate and across said opening;
a cut length stop slidably connected to said base plate, said cut length stop positioned to abut an end of said window blind assembly at a distance from said opening; and
cutting means supported above said base plate for modifying said window blind assembly, said cutting means aligned with said opening.

9. The apparatus of claim 8, said opening being perpendicular to said base plate.

10. The apparatus of claim 8, further comprising a ruler, said ruler attached along said wall and being parallel with said window blind assembly.

11. The apparatus of claim 10, said ruler having an origin at said opening of said wall and positively incrementing in both directions along said wall from said opening.

12. The apparatus of claim 8, said cutting means comprising a saw.

13. The apparatus of claim 12, said saw being replaceable.

14. A method for modifying a window blind assembly, the method comprising:
placing a window blind assembly onto a base plate and against a wall;
aligning the window blind assembly across an opening in said wall and in relation to a ruler attached along said wall;
determining amount to modify on said window blind assembly with respect to said ruler;
securing a first side of said window blind assembly; and
cutting said window blind assembly along said opening.

15. The method of claim 14, further comprising:
securing a second side of said window blind assembly.
